(19) United States
(12) Patent Application Publication
(10) Pub. No.: US 2005/0175852 A1
(43) Pub. Date: Aug. 11, 2005

(54) Thin silica film and silica-titania composite film, and method for preparing them

(76) Inventors: Hiroki Okudera, Aichi (JP); Toru Nonami, Aichi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/505,878

(22) PCT Filed: Mar. 19, 2003
(86) PCT No.: PCT/JP03/03326

(30) Foreign Application Priority Data
Mar. 19, 2002 (JP) 2002-076093
Mar. 19, 2002 (JP) 2002-075995

(51) Int. Cl. B05D 1/18; B05D 3/12

(52) U.S. Cl. 428/548; 427/430.1; 427/346; 427/372.2

(57) ABSTRACT

The present invention provides a method for preparing a high-density thin silica film with excellent translucency on a substrate having an arbitrary profile and surface characteristics, a method for controlling the surface roughness of the thin silica film, a method for preparing a silica-titania composite film, a composite film with photocatalytic action obtained by these methods, and a composite structure.

### TECHNICAL FIELD

The present invention relates to a manufacturing method and a composite structure for a novel thin silica film, and more particularly relates to a film forming method whereby it is possible to form a film on a substrate surface having the arbitrary surface characteristics and surface profile and to control the film thickness, which is a new film forming method whereby it is possible to create a uniform and high-quality thin silica film with a predetermined film thickness on a substrate; and to a composite structure having a thin silica film formed by this method on its surface and having high translucence and other such properties. This thin silica film can be utilized in a variety of ways, such as in electrical insulating films, high-purity protective films with high intensity, optical waveguide films with high translucence, low reflecting coating films with a low refractive index, repairing films for repairing minute defects in a substrate surface to restore its smoothness, undercoating films for suppressing chemical diffusion from the substrate, surface treating films for modifying a substrate surface to an arbitrary surface roughness, and the like.

Also, the present invention relates to a novel silica-titania composite film and to a manufacturing method and composite structure thereof, and more particularly relates to a composite film having one or a plurality of layers consisting of a metal compound film with a metal other than titanium as a component, and having a titanium oxide film composed of the crystalline anatase phase on the outermost surface; and to a manufacturing method and composite structure thereof. The present invention is effective as a method for producing a composite film in which a uniform and high-quality titania film is formed on an arbitrary substrate in a low temperature range of around 350° C. Also, this composite film can be utilized in a variety of ways, such as in environmental cleanup materials for wastewater treatments, water purification treatments, and other applications requiring photocatalytic activity; antifouling films with strong hydrophilicity; transparent coherent coloring films; photocatalytic functional window glass with photocatalytic and transparent properties, optical waveguide films with a high refractive index, and the like.

### BACKGROUND ART

Sol-gel methods, sputtering methods, LPD methods, and the like, for example, are conventionally well-known as chemical methods for forming a thin silica film on a substrate surface. Sol-gel is a method wherein partially hydrolyzed stable silica sol is prepared by adding a reaction catalyst, a stabilizer, or the like to an alcohol solution of silicon alkoxide, the resulting material is applied as a coating solution to a substrate surface by dipping, spinning, or other such methods, to cause hydrolysis and polymerization reaction of the coating on the substrate surface, and then a film is formed by heating and calcining the coating. Sputtering is a method wherein a substrate is fixed in a vacuum container, and a thin silica film is formed on the substrate surface by depositing silicon or a silicon compound vaporized by various methods on the substrate surface in the container. LPD is a method wherein a thin silica film is formed on a substrate surface by utilizing the changes in the degree of supersaturation in an aqueous solution to precipitate silicon fluoride dissolved in the solution and to adhere the silicon fluoride to the substrate surface.

However, the following are presented as problems with these conventional techniques. First, although sol-gel is a method whereby the film can be formed at a low temperature in a relatively short amount of time, it is normally difficult to maintain uniformity in the film. Also, stabilizers and other such organic materials tend to remain in the silica that constitutes the film, which require high-temperature calcining to be removed. Also, the acidic gas emitted during calcining has adverse effects on the calcining apparatus. Sputtering methods have problems in that it is difficult to form a film on a surface with a complicated shape, the reaction apparatus is complicated and expensive, and the method is costly. LPD methods have problems in that the process is complicated and water or the like tends to remain in the silica that constitutes the film.

Presented below are examples of methods for manufacturing a thin silica film that utilizes hydrolysis of a metal alkoxide.

1) Japanese Patent Application Laid-Open No. H9-295804 “Method of Silica Thin Film”

However, methods that utilize hydrolysis of a metal alkoxide have the following problems: 1) no method for strictly controlling the film thickness has yet been proposed; 2) the surface roughness cannot be controlled; and 3) no coating methods have yet be proposed that could be used with hydrophobic substrate surfaces.

Also, in conventional practice, known examples of chemical methods for forming a titania thin film on a substrate surface include coating methods, sol-gel methods, chemical gas phase transfer methods, self-organizing monomolecular film methods, Langmuir-Blodgett methods, sputtering methods in a vacuum, and new film forming methods that use chemical reactions other than sol-gel methods. First, coating methods are those in which a substrate is coated with amorphous or crystalline anatase-phase titania fine particles along with a binder. Sol-gel methods are those in which a stabilized titania sol is prepared by a process in which an alcohol solution of a titanium alkoxide is partially hydrolyzed by adding a stabilizer, the sol is applied to a substrate surface as a coating fluid by dipping, sputtering, or the like, to cause a dehydropolycondensation reaction of the coating on the substrate surface, and then a stable amorphous thin film is formed by drying. In this method, the amorphous film is converted to the crystalline anatase phase as necessary by heating and calcining.

Chemical gas phase transfer methods are those in which a substrate is fixed in a reaction container, a vaporized titanium compound is fed into the container, and the chemical bonding between the substrate surface and the gas is utilized to form a titania film on the substrate surface. At this point, a crystalline anatase phase is formed on the substrate surface by heating the substrate. Self-organizing monomolecular film methods are methods which resemble chemical gas phase transfer methods and in which a substrate is fixed in a reaction container, a liquid phase or gas phase containing a titanium compound is fed into the container, and the chemical bonding between the monomolecular film formed on the substrate surface and the titanium is utilized to form a titania film on the substrate surface. The Langmuir-Blodgett method is a method wherein a hydrophobic liquid in which fine particles of amorphous titania or the crystalline anatase phase are suspended is spread across the surface of standing water, and a film is formed on a substrate surface by dipping or another such method to form a film.

Sputtering methods are methods in which a substrate allowed to stand in a high-vacuum reaction chamber is heated to increase the reactivity of the substrate surface, titanium atoms or molecules of a titanium oxide complex are evaporated in the reaction chamber using heating, laser irradiation, or other such methods, and the substrate surface is coated with amorphous titania or the crystalline anatase phase, similar to the above-described chemical gas phase transfer methods. Furthermore, a film forming technique has been developed wherein a new coating liquid resulting from a different chemical reaction than in sol-gel methods is prepared, and an anatase-phase titania thin film is formed by calcining this liquid after it is applied. It is assumed in this film forming technique that an anatase-phase titania thin film can be obtained by applying the coating liquid onto a substrate, drying the resulting film, and then heating the dried film at 400 to 500° C.

However, the weathering resistance of the film formed by this coating method depends on the weathering resistance of the binder, the drawback of which is that the stronger the photocatalytic activity of the crystalline anatase phase, the faster the deterioration of the binder resulting therefrom. Sol-gel methods are methods whereby a film can be formed at a low temperature in a relatively short amount of time, but these methods have problems in that 1) creating the sol solution for coating is time-consuming; 2) it is difficult to prepare or apply a sol solution under atmospheric conditions; 3) organic matter tends to remain in the titania that constitutes the film, and calcining commonly needs to be performed at a high temperature of 600° C. or more to convert the phase that constitutes the film into crystalline anatase in order to ensure photocatalytic properties; and 4) crystallization into crystalline anatase is inhibited by the diffusion of chemicals from the substrate due to heating.

With the above-described Langmuir-Blodgett method, it is important that the substrate surface be a hydrophobic and smooth flat surface. Chemical gas phase transfer methods and sputtering methods have their own specific problems in that there is a limit on the size of the substrate, it is difficult to form a film on a surface with a complicated profile, and the possibility of forming a film depends on the heat resistance of the substrate or the surface characteristics of the substrate, so these methods are lacking in versatility. Also, the reaction apparatus is complicated and expensive, which leads to high costs. Self-organizing monomolecular film methods have a complicated treatment procedure for the substrate and are also lacking in versatility. Furthermore, techniques for forming an anatase-phase titania thin film with a chemical reaction different than in sol-gel methods require a process of heating at 400° C. or more to obtain the desired anatase phase titania thin film, but it is preferable that this heating temperature be lower in view of the heat resistance limit of the substrate.

### DISCLOSURE OF THE INVENTION

As a result of earnest research conducted under such circumstances and in view of the above-described conventional techniques, and upon conducting a study aimed at developing a new film-forming technique whereby it is possible to actively solve the problems of the above-described conventional techniques, the inventors perfected the present invention upon after having discovered with the aid of some additional research that the desired objects can be achieved by creating a low-density silica colloid with a diameter of 1 to 30 nm in a solution through hydrolysis of a silicon alkoxide, developing the process whereby a film is formed in the solution through deposition and dehydropolycondensation with the substrate, and controlling these processes.

Specifically, an object of the first embodiment of the present invention is to solve the problems with the above-described conventional techniques and to provide 1) a manufacturing method for a thin silica film whereby an amorphous thin silica film can be formed on a substrate surface with the arbitrary shape irrespective of hydrophilicity or hydrophobicity; 2) a method for controlling the surface roughness of the thin silica film; and 3) a method for strictly controlling the film thickness of the thin silica film by setting the reaction time.

Another object of the present invention is to provide a method for forming a uniform and high-quality thin silica film on a substrate by the above-described methods.

Yet another object of the present invention is to provide a highly translucent composite structure having on its surface layer a thin silica film compounded by forming a thin silica film obtained by the above-described methods on the surface layer of an arbitrary structure.

Furthermore, in view of the above-described conventional techniques, and as a result of earnest research intended to actively solve the problems with the above-described conventional techniques, and particularly to develop a new film-forming technique whereby a uniform and high-quality titanium oxide film can be formed at a low temperature range of around 350° C., the inventors have discovered that the desired objects can be achieved by forming a silica film on a substrate under specific conditions, and also forming a titanium oxide film to create a silica-titania composite film; and have completed the present invention with further research.

Specifically, an object of the second embodiment of the present invention is to solve the problems with the above-described conventional techniques and to provide a manufacturing method for a new crystalline anatase-phase thin film whereby a film can be formed on a substrate surface of an arbitrary material having an arbitrary profile and surface characteristics at a far lower temperature than with conventional methods.

Another object of the present invention is to provide a novel, highly functional silica-titania composite film that is uniform and high quality, and that has photocatalytic action when formed by the above-described methods.

Yet another object of the present invention is to provide a composite structure with photocatalytic action, having on its surface layer the composite film compounded by forming the composite film on the surface layer of an arbitrary structure.

Next, the first embodiment of the present invention will be described in further detail.

As a result of extensive studies into the problems of the above-described conventional techniques, the inventors have discovered that 1) a precipitation product of amorphous silica resulting from the hydrolysis of silicon alkoxide is composed of secondary particles in the form of an aggregated stabilized product of unstable primary particles with a diameter of no more than several dozen nanometers, produced by a hydrolysis reaction process; 2) when an arbitrary substance is immersed in the reaction solution in the process of producing a precipitation product, the primary particles adhere to the surface of the substance if the surface of the substance is hydrophilic, and a uniform thin film is formed (FIG. 1); 3) the thin silica film thus obtained is fine, requires no heating or calcining after drying, and has high adhesion and intensity; and 4) if the surface of the substrate is hydrophobic, the primary particles and the secondary particles produced by condensation of the primary particles in the reaction solution have a low probability of adhering to the substrate surface due to Brownian motion and van der Waals binding in the solution, whereby a uniform thin film with a high degree of surface roughness is formed (FIG. 2). FIG. 1 schematically shows the process of forming a thin silica film on a substrate with a hydrophilic surface and a smooth thin film obtained thereby. FIG. 2 schematically shows the process of forming a silica film on a substrate with a hydrophobic surface and a thin film with a high degree of surface roughness obtained thereby.

The present invention is based on the discoveries of these new conditions, and relates to a method for manufacturing a new thin silica film characterized in that silica produced by hydrolysis of silicon alkoxide is bonded to a substrate surface by immersing a substrate in a solution composed of silicon alkoxide, alcohol, ammonia, and water, and maintaining the temperature at room temperature or less. In a wider sense, the present invention is intended to provide a method of forming a thin silica film on the surface of a substrate, a method for controlling the surface roughness by controlling the state of the substrate surface, and a composite structure having on its surface layer the thin silica film obtained by these methods.

In the present invention, the solution, to be used to form a thin film and, composed of a silicon alkoxide, alcohol, water, and an alkali, comprises the following: 1) preferably silicon methoxide, silicon ethoxide, silicon isopropoxide, or silicon butoxide as the silicon alkoxide, 2) preferably methanol, ethanol, isopropanol, or butanol as the alcohol solvent, and 3) water required for hydrolysis and an alkali, preferably ammonia, as the catalyst for promoting hydrolysis. These are preferably mixed in the following concentration ranges, respectively.
1) Silicon alkoxide: 0.05-0.5 mol/L
2) Alkali (ammonia): 0.5-5.0 mol/L
3) Water: 1-10 mol/L

Next, an outline of the methods of the present invention is shown in FIG. 3.

The silica film of the present invention is formed by using silicon alkoxide, alcohol, ammonia, and water, which are stirred into a mixture in predetermined amounts, then a substrate is immersed therein, and the substrate is held there from several minutes to several dozens of hours at a predetermined set temperature.

Whether or not a film is formed on the substrate surface is dependent on the production speed and state of polymerization of the silicon oxide produced through hydrolysis of the silicon alkoxide, and the weight ratio of silicon alkoxide and water is vital in the adjusted solvent compositions. The forming of a film on the substrate surface depends on the adhesion of the transient primary particles 1 to 30 nm in diameter produced in the hydrolysis reaction process. Therefore, the primary particles adhere to the surface of the substance to form a uniform film if the surface of the substrate is hydrophilic, and irregularities occur in the surface of the film due to a reduction in the probability that the primary particles will deposit on the surface and to the deposition of aggregated secondary particles if the surface of the substrate is hydrophobic. Therefore, the surface characteristics of the substrate are vital for the profile of the desired film surface.

In the present invention, examples of materials that can be used as the substrate include metal; soda lime glass, silica glass, or other such glass; polyethylene, polystyrene or other such plastics; and silicon rubber. However, the substrate is not limited to these examples, and many other substances can be used. Also, the substrate surface may be either hydrophilic or hydrophobic, and the substrate surface may, for example, be made hydrophobic by subjecting the substrate surface to a surface treatment via chemical modification, as typified by fluorine treatment. The state of the substrate surface may be either smooth or irregular. The optimum mixture ratio of the components from which a film is formed on a hydrophobic substrate surface is a mixture ratio at which monodisperse spherical silica particles can be formed as secondary particles in the solvent.

The optimum mixture ratio of the above-described components from which a film is formed on a hydrophilic substrate surface is either 1) a mixture ratio at which monodisperse silica particles can be formed as secondary particles in the solvent; or 2) a mixture ratio that yields a somewhat lower hydrolysis rate than in the 1), that is, a mixture ratio in which the water concentration or ammonia concentration is lower than in the conditions in which monodisperse silica particles can be formed as secondary particles in the solvent. When a uniform film is not formed as a result of a rapid progress in hydrolysis, the hydrolysis can be suppressed by setting a low treatment temperature, and a uniform film can be obtained. Therefore, in the present invention, the silicon alkoxide concentration is not vital, and a uniform silica film can be formed by increasing the water concentration or ammonia concentration when the silicon alkoxide concentration is reduced, and by setting a long reaction time.

When the silicon alkoxide concentration is increased, a uniform thin silica film can be formed by reducing the water concentration or ammonia concentration and by reducing the reaction temperature. In the present invention, as previously described, one or more of the following can be used as the silicon alkoxide: silicon methoxide, silicon ethoxide, silicon isopropoxide, and silicon butoxide. One or more of the following can be used as the solvent: methanol, ethanol, isopropanol, and butanol. Of these, silicon tetraethoxide is preferred as the silicon alkoxide, and ethanol or isopropanol is preferred as the solvent. The concentrations thereof are 0.05 to 0.5 mol/L, and preferably 0.1 to 0.2 mol/L. Water induces hydrolysis in the silicon alkoxide, which is needed to produce silica. The amount thereof is within a range of 1 to 100 in relation to the silicon alkoxide in terms of the molar ratio.

In the present invention the alkali induces hydrolysis in the silicon alkoxide and is needed as a catalyst to produce a silica colloid. In the present invention, ammonia is preferably used as the alkali. The amount thereof is within a range of 1 to 100 in relation to the silicon alkoxide in terms of the molar ratio. The temperature at which the reaction solution is maintained in the film forming process may be below freezing or may be room temperature or greater, but is preferably 0° C. or greater and 30° C. or less. In this case, the reaction may be performed in an airtight container in order to prevent volatilization of the solvent. The reaction solution must be maintained in a dynamic state in order to promote deposition of a low-density silica colloid onto the substrate. In this case, examples of the method for maintaining the reaction solution in a dynamic state include, but are not limited to, shaking the reaction solution, or preferably vigorously shaking the reaction tank, circulating the solvent, or vibrating the substrate. Also, the operating means for these methods are not particularly limited, and any desired means can be used. It is extremely vital in the present invention to maintain the reaction solution in a dynamic state. When the reaction solution is left standing, it is difficult to achieve optimum reaction conditions, and it is also difficult to achieve the desired objects. In the present invention, the phrase “maintain in a dynamic state” means that the reaction solution is kept in a non-stationary state without being left standing.

In the present invention, the speed at which the film is formed can be expressed as a logarithmic function of the holding time by appropriately setting the reaction conditions. Also, since the forming of the film depends on the adhesion of the transient primary particles, the time at which the substrate is first immersed in the reaction solution may be anytime during which the reaction is continuing. Therefore, the desired film thickness can be attained by appropriately setting the starting time of immersion and the subsequent holding time. The speed at which the film is formed is proportional to the silicon alkoxide concentration in the solvent. Therefore, the film thickness can be controlled even in the same treatment time by adjusting the silicon alkoxide concentration. The probability that the transient primary particles will adhere to the substrate surface can be reduced by making the surface of the substrate hydrophobic, and the probability that the secondary particles as aggregates of the primary particles will deposit on the substrate surface can simultaneously be increased. Therefore, the surface profile of the thin film can be controlled by increasing the hydrophobicity of the substrate surface. As previously described, it is extremely vital at this point that the reaction solution be maintained in a dynamic state. Therefore, vigorously shaking the reaction tank, circulating the solvent, or vibrating the substrate is included as a vital constituent element in the present invention.

The amorphous silica film obtained by the methods of the present invention is already of a high density in a layered state, and the drying process can be omitted. Furthermore, sufficient hardness is achieved by drying at room temperature. The amorphous silica film obtained by the methods of the present invention is made insoluble in alcohol due to drying, and a thicker film can be obtained by repeating this treatment. Furthermore, subjecting the resulting film to hydrolysis makes it possible to remove the OH and alkyl groups remaining in the structure of the amorphous silica film obtained by the methods of the present invention, whereby it is possible to form a thin film composed of high-purity amorphous silica.

The silica film of the present invention has excellent properties of high translucence, high insulation, high density, high water repellency (resulting from being made hydrophobic), and the like. Because of this, the silica film can be formed and compounded on a surface with the desired structure. A composite structure endowed with the properties described above can thereby be formed. The silica film of the present invention can be utilized, for example, as an insulating film, a low-reflective coating film, an optical waveguide film, light-transmissive material, an undercoating film, a surface treating film, or the like, and the silica film can also be used in various composite structures as the surface layer of a film, optical glass, crystal panel, Braun tube, glass window, protective cover, material, electronic component, structure, and the like.

In the present invention, the substrate is immersed in a solvent composed of a silicon alkoxide, alcohol, water, and an alkali, and a low-density silica colloid with a diameter of 1 to 30 nm is produced in the solution by hydrolysis of the silicon alkoxide in the alcohol solvent. In the thin silica film formation process, maintaining the reaction solution in a dynamic state by the desired means makes it possible to promote film formation in the solution due to the deposition and dehydropolycondensation of the components on the substrate. A uniform silica film with the desired film thickness can thereby be formed on the substrate in the solution. In this case, the film thickness of the silica film can be controlled by the silicon alkoxide concentration, the water concentration, the catalyst concentration, the treatment temperature, the treatment time, the treatment frequency, and the like. Also, the surface profile of the thin film can be controlled by increasing the hydrophobicity of the substrate surface. The amorphous silica film formed by the methods described above is uniform, has a high density, and can be endowed with a high degree of hardness by drying at room temperature. Also, a high-purity and high-density amorphous silica film can be formed by heating and baking. The silica film of the present invention has the properties of improving the translucency of a glass substrate, for example, as is shown in the embodiments hereinafter described.

To describe the deposition and dehydropolycondensation of the low-density silica colloid on the substrate in the present invention, the transient silica produced by hydrolysis of the silicon alkoxide repeatedly condenses and re-dissolves in the solution, and within the transient silica colloid formed by condensation, only those particles that collide with each other and assume a reduced surface area/volume ratio reach the solid phase without being re-dissolved. This transient silica colloid is constantly being produced and dissolved repeatedly while the reaction is taking place, and the size thereof is proportionate to the degree of supersaturation of the dissolved silica. In the present invention, if the reaction is taking place, the start of substrate immersion and the duration time can be arbitrarily set, and a silica film can be formed on the substrate surface. Also, maintaining the reaction solution in a dynamic state by moving the solution and the substrate relative to each other or the like makes it possible to deposit the transient silica colloid to the substrate surface even if the surface of the substrate is hydrophobic.

Next, the second embodiment of the present invention will be described in further detail.

As a result of earnest research intended to solve the problems of the above-described conventional techniques, the inventors have discovered that 1) the hydrolyzed titanium alkoxide in a solution composed of a titanium alkoxide, alcohol, and water forms primary particles of a transient titania colloid with a diameter of several dozen nanometers or less; and 2) by immersing the substrate in the solution composed of a titanium alkoxide, alcohol, and water, the solution is caused to deposit on the substrate surface due to the Brownian motion and van der Waals binding in the solution, and a titania thin film is formed on the surface of the substrate.

Furthermore, the inventors have discovered that 3) the diffusion of chemicals from the substrate to the titania thin film can be reliably prevented and a uniform and high-quality titania thin film can thereby be formed by disposing a metal compound film whose metal component is different from titanium, for example, an amorphous thin silica film, between the thin film and the substrate, and furthermore, the titania constituting the surface layer of the composite film can be easily converted to crystalline anatase by heating and calcining the composite film at around 350° C.

The present invention relates to a composite film characterized by having a metal oxide film or another such metal compound film other than titanium with a uniform thickness of 0.01 to 1.00 μm, preferably an amorphous silica film, between the surface of the substrate and the titanium oxide, wherein the titanium with a uniform thickness of 0.01 to 100 μm constituting the surface layer is in a crystalline anatase phase. Furthermore, the present invention relates to a method for manufacturing the composite film and to a highly functional composite structure having the composite film on the surface thereof.

The composite film of the present invention, in which the surface layer is a crystalline anatase-phase titania thin film, is formed via the following steps: a) the substrate surface is coated with a metal compound film, for example, a metal oxide thin film, of a metal other than titanium arranged in a single layer or a plurality of layers; b) the substrate in a) is coated with an amorphous titania thin film; and c) the coated film from b) is calcined at a temperature of 300° C. or more. The metal compound film of a metal other than titanium, for example, an oxide thin film, is formed between the substrate and the titania thin film with the object of impeding the diffusion of chemicals between the substrate and the titania thin film, and thereby making it possible to form a uniform and high-quality titania thin film. It is preferable to use a crystalline or silica film to achieve these objects, and an amorphous silica film may be used if the objects can be achieved. However, the film is not limited thereto, and it is possible to similarly use a compound with low reactivity at high temperatures, for example, a silicon compound, preferably silicon nitride, other nitrides, or other such compounds that have the same effects.

Forming an amorphous silica film preferably consists of immersing a substrate in a solution composed of a silicon alkoxide, alcohol, water, and ammonia, and hydrolyzing the silicon alkoxide to form an amorphous silica film on the surface of the substrate. In this case, the reaction solution must be maintained in a dynamic state (non-stationary conditions). The film forming process can thereby be optimized to form a uniform and high-quality thin silica film. When the desired thickness is not achieved, high density can be attained in the silica film by repeating this operation, drying the substrate coated with the silica film, and, if necessary, heating and calcining the dried and coated substrate at a temperature of 300° C. or more and 1000° C. or less, preferably around 350° C., or by another such method. However, the process is not limited to these methods. The amorphous silica film is preferably further increased in density by heat treatment. Diffusion of chemicals from the substrate to the titania thin film can be reliably impeded by forming this higher-density amorphous silica between the substrate and the titania film, whereby it is possible to form a uniform, high-quality, and highly durable titania film. When such an amorphous silica film is not formed, it is difficult to convert the titania film described above to a crystal anatase phase, as is shown in the embodiments hereinafter described. In the methods of the present invention, the formation of the silica film in the method of creating an amorphous silica film is unaffected by the size of the substrate, the material, the profile, or the hydrophilicity/hydrophobicity of the surface.

Therefore, the formation of a silica-titania composite film of the present invention, which is configured from this silica film and a titania film bonded thereon, is also unaffected by the size of the substrate, the material, the profile, or the hydrophilicity/hydrophobicity of the surface. It is thereby possible to form a titania film on a substrate surface of an arbitrary material having an arbitrary profile and surface characteristics. In the present invention, possible examples of the substrate include metal; metal oxides; soda lime glass, silica glass, and other such glass; polyethylene, polystyrene, and other such plastics; silicon rubber; and the like, but the substrate is not limited thereto and many other examples are possible. The surface state of the substrate may be either smooth or irregular. The substrate surface may also be either hydrophilic or hydrophobic, but is not particularly limited to these properties.

In the present invention, formation of an amorphous titania thin film, which is the first step in forming a crystalline anatase-phase thin film, is achieved by immersing a substrate in a solution composed of a titanium alkoxide, alcohol, and water and holding the substrate therein for a predetermined time, whereby the titanium alkoxide is hydrolyzed and a low-density titania colloid with a diameter of 1 to 30 nm is produced in the solution, a titanium oxide film is formed on the surface of the substrate due to the deposition and dehydropolycondensation of these components on the substrate, and this operation is repeated when the desired thickness cannot be achieved by one operation. Since the production of the amorphous titania film results from the coating of the substrate surface with transient titania colloid primary particles, which are several dozen nanometers or less in diameter and are produced in the solvent, the formation of an amorphous titania film is unaffected by the size of the substrate, the material, the profile, or the hydrophilicity/hydrophobicity of the surface. Therefore, the surface of the underlying silica film portion can be chemically modified prior to forming the amorphous titania film portion, for example.

Whether or not a uniform and high-quality titania film is formed on the substrate surface is determined by the state of polymerization of the titanic acid produced through hydrolysis of the titanium alkoxide and by the kinetics by which the transient titania colloid primary particles with a diameter of several dozen nanometers or less are produced, and within the components of the prepared solution, the weight ratio of titanium alkoxide to water is vital. Therefore, the titanium alkoxide concentration is rather unimportant, and specifically, when the titanium alkoxide concentration is reduced, a titania film can be formed by increasing the water concentration and by setting a long reaction time.

In the present invention, as previously described, either one or a mixture of two or more of the following is used as the titanium alkoxide: titanium methoxide, titanium ethoxide, titanium isopropoxide, and titanium butoxide, but it is preferable to use titanium tetraethoxide or titanium tetraisopropoxide. One or a mixture of two or more of methanol, ethanol, isopropanol, and butanol is used as the solvent, but it is preferable to use ethanol or isopropanol. A suitable concentration range thereof is 0.01 to 1.0 mol/L, but a more preferable concentration range is 0.025 to 0.1 mol/L.

Water induces hydrolysis, which is needed to produce the titania colloid. The amount thereof is within a range of 1 to 100 in relation to the titanium alkoxide in terms of the molar ratio. The holding temperature of the reaction solution in the film formation step may be below freezing, but is preferably 0° C. or greater and 100° C. or less. It is more preferably near room temperature. In this case, the reaction is preferably performed in an airtight container in order to prevent volatilization of the solvent.

The reaction may be performed in a stationary manner, but it is preferable to maintain the reaction solution in a dynamic state to obtain a uniform film, which can be achieved by circulating the solution, vibrating the substrate, vigorously shaking the reaction tank, or the like, and the reaction is preferably performed in an environment conducive to vigorous shaking (under non-stationary conditions). In the methods of the present invention, the speed at which the film is formed can be expressed as a logarithmic function of the holding time. Also, since the formation of the film is a result of deposition of transient titania colloid primary particles with a diameter of several dozen nanometers or less produced by hydrolysis of the titanium alkoxide, the film thickness can be strictly controlled by appropriately setting the starting time of substrate immersion and the holding time. The amorphous titania film obtained in the present invention can be converted to a high-purity, high-density crystalline anatase phase by calcining at 300° C. or more and 1000° C. or less, preferably around 350° C. At this time, the OH and alkyl groups contained in the film structure can be removed, whereby it is possible to form a composite film whose surface layer is composed of a highly pure crystalline anatase phase.

In the present invention, a substrate having one or a plurality of layers of a metal compound film with a metal other than titanium as a component, for example, a metal oxide film, or preferably a silica film on its surface, is immersed in a titanium alkoxide solution, and the titanium alkoxide is hydrolyzed to produce a low-density titania colloid with a diameter of 1 to 30 nm in the solution, a titanium oxide film is formed on the surface of the substrate in the solution due to the deposition and dehydropolycondensation of these components on the substrate, and these steps are optimized to make it possible to form a uniform and high-quality titania film on the substrate. In the present invention, the diffusion of chemicals from the substrate to the titania thin film can be reliably impeded by forming the silica film portion in the bottom layer of the titania film portion, whereby it is possible to form a uniform and high-quality titania film with high endurance.

The methods of the present invention make it possible to form a composite body in which the titania film is formed on the substrate surface of an arbitrary material having an arbitrary profile and surface characteristics. Also, the composite body can be converted to a high-purity crystalline anatase phase by calcining at a low temperature of 300° C. or more and 1000° C. or less, and preferably around 350° C. The transient titanic acid produced by hydrolysis of the titanium alkoxide repeatedly condenses and re-dissolves in the solution, and within the transient titania colloid formed by condensation, only those particles that collide with each other and assume a reduced surface area/volume ratio reach the solid phase without being re-dissolved. This transient titania colloid is constantly being produced and dissolved repeatedly while the reaction is taking place, and the size thereof is proportionate to the degree of supersaturation of the dissolved titanic acid. In the present invention, it was realized as a result of such discoveries that if the reaction is taking place, a titania film can be formed on the substrate surface even if the start of substrate immersion and the duration time are arbitrarily set. FIG. 6 shows an outline of the method for manufacturing the composite film of the present invention.

### BRIEF DESCRIPTION OF THE DRAWINGS

FIG. 1 shows a schematic view of the process of forming a smooth film on a substrate in the present invention;

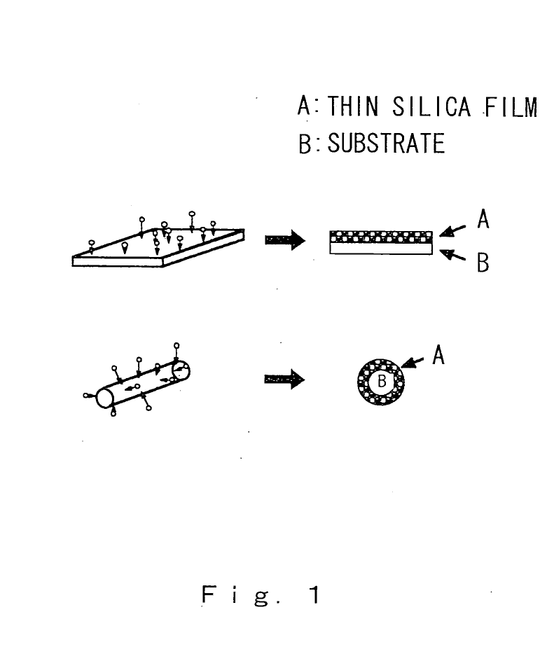

FIG. 2 shows a schematic view of the process of forming a film with high surface roughness on a substrate in the present invention;

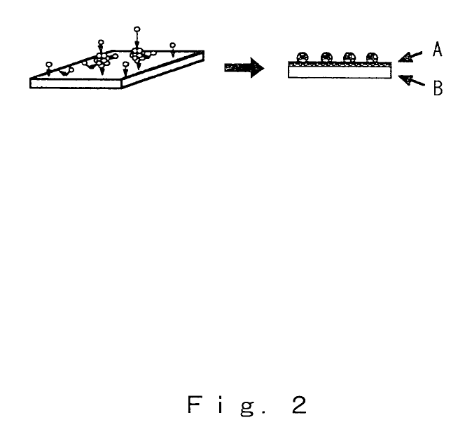

FIG. 3 shows an outline of the methods of the present invention;

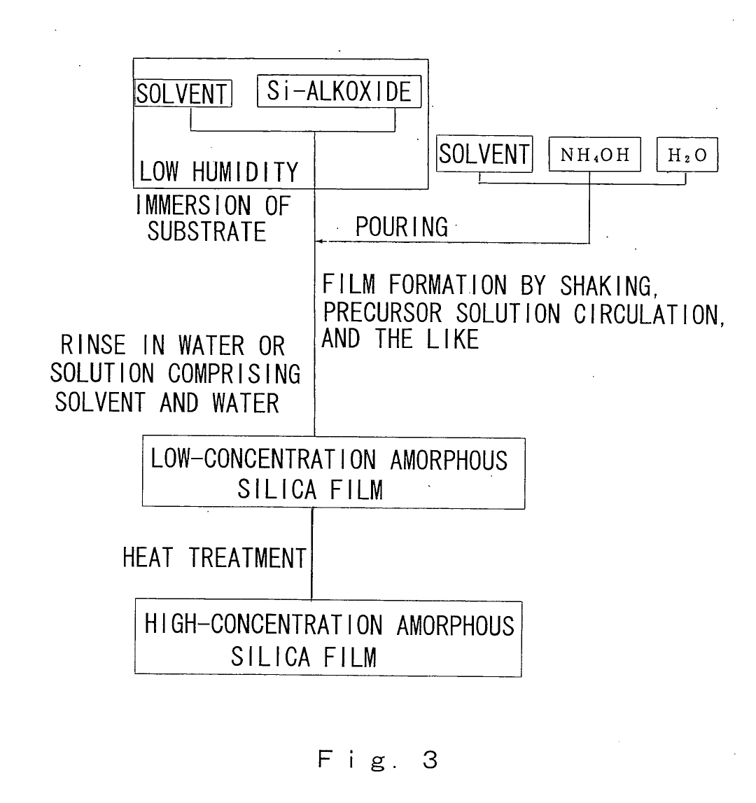

FIG. 4 shows the relationship between the film thickness of the silica film and the reaction time;

FIG. 5 shows the results of measuring the translucency of glass with an ultraviolet and visible light spectrophotometer;

FIG. 6 shows an outline of the method for manufacturing the composite film of the present invention;

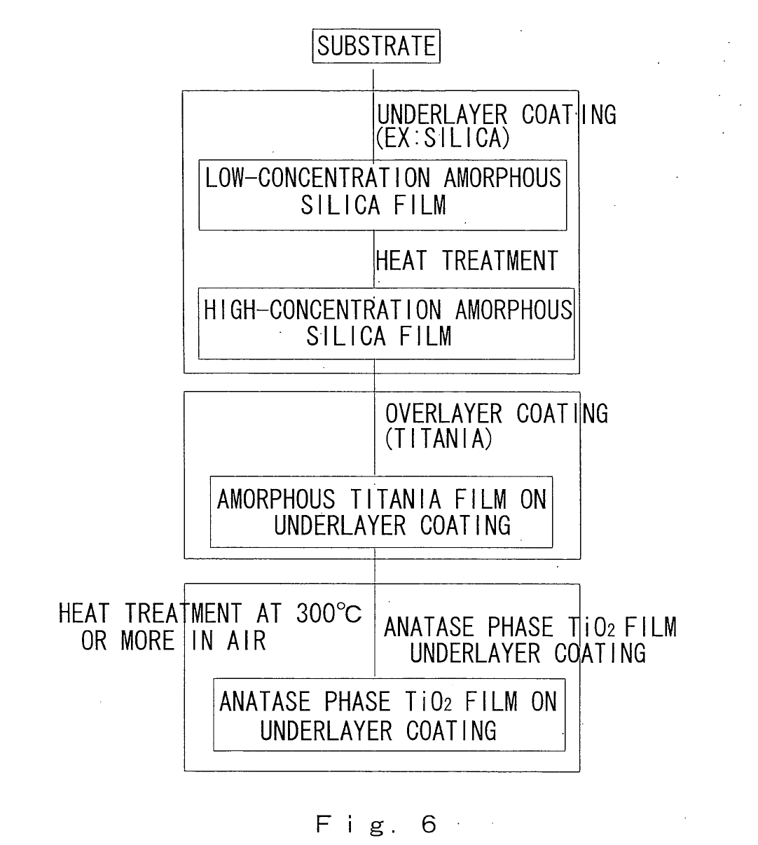

FIG. 7 shows the results of X-ray powder diffraction of the composite film (the diffraction line at the diffraction angle of 25 degrees indicates the presence of a crystalline anatase phase);

FIG. 8 shows the results of X-ray powder diffraction of the composite film (the diffraction line at the diffraction angle of 25 degrees indicates the presence of a crystalline anatase phase);

FIG. 9 shows the relationship between the film thickness of the titania film and the reaction time;

FIG. 10 shows the relationship between the film thickness of the titania film formed on hydrophilic and hydrophobic substrates and the reaction time; and

FIG. 11 shows the results of measuring the transmittance of light in glass in the ultraviolet and visible light regions.

### BEST MODE FOR CARRYING OUT THE INVENTION

Next, Examples of the first embodiment of the present invention will be described in detail.

### EXAMPLE 1

As the substrates, a silicon substrate with a hydrophilic surface, and a silicon substrate with a highly hydrophobic surface that had been chemically modified (fluorine treatment) with a monomolecular film of 1H,1H,2H,2H-perfluorodecyl trimethoxysilane were used. A solution was prepared in which silicon tetraethoxide was dissolved in ethanol such that the concentration was 0.11 mol/L during the reaction, as well as a solution in which water was dissolved in ethanol such that the concentration was 3.0 mol/L, and ammonia was dissolved such that the concentration was 1.0 mol/L during the reaction, and the substrates were immersed in the first solution. While the container with the first solution was vigorously shaken to maintain the reaction solution in a dynamic state, the second solution was added therein and the container was sealed with a film, and the temperature was held at 20° C. while further vigorously shaking the container to maintain the reaction solution in a dynamic state.

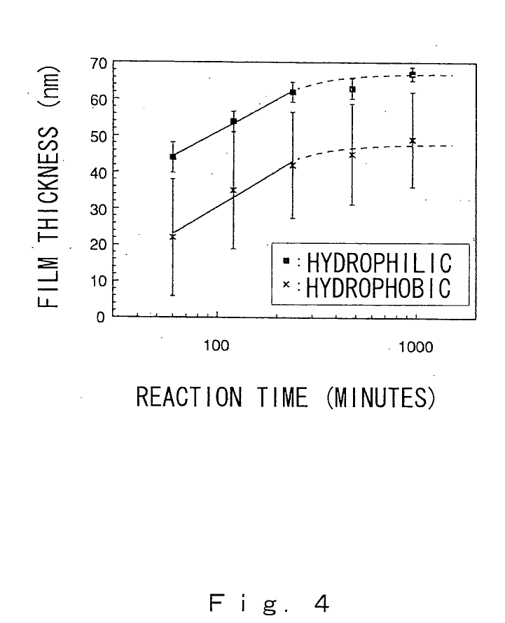

After a predetermined time had passed, the substrates were taken out, cleaned with a solution consisting of 0.648 mL of water added to 120 mL of ethanol, and dried at 70° C. The film thickness of the resulting silica film was examined with an atomic force microscope (AFM). The film thickness is expressed by the following formulas as a function of time t (minutes) during a reaction period that lasted from 60 to 240 minutes (FIG. 4).
On an untreated silicon plate: d (nm)=30 log(t)−8.8
On a hydrophobic treated silicon plate: d (nm)=33 log(t)−36

Also, the surface roughness of the silica film on the silicon single crystal substrate corresponded to an RMS roughness of 1 nm. The surface roughness of a silicon single crystal substrate treated with fluorine corresponded to an RMS roughness of 10 to 14 nm.

### EXAMPLE 2

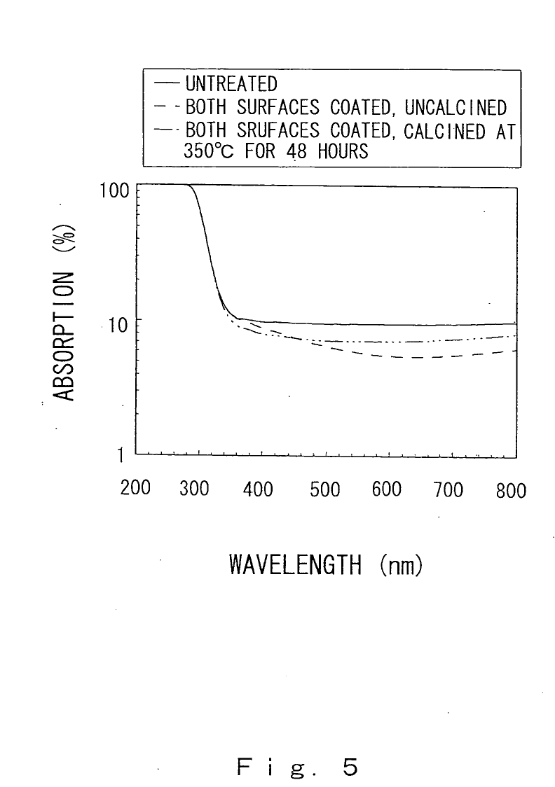

In Example 1 described above, the substrate was soda lime glass, and both surfaces of the glass plate were coated with an amorphous silica film with a film thickness of 137 nm. The light transmittance of this sample was measured with an ultraviolet and visible light spectrophotometer. Upon comparing the results with the untreated substrate, it was clear that the light transmittance is improved by the amorphous silica film coating (FIG. 5).

Next, Examples of the second embodiment of the present invention will be described in detail.

### EXAMPLE 3

(1) Thin Silica Film Formation

In the present Example, soda lime glass was used for the substrate. The silica film was formed by the following procedure. A solution was prepared in which silicon tetraethoxide was dissolved in ethanol such that the concentration was 0.22 mol/L during the reaction, as well as a solution in which water was dissolved in ethanol such that the concentration was 6.0 mol/L, and ammonia was dissolved such that the concentration was 2.0 mol/L during the reaction, and the substrate was immersed in the first solution. While the container with the first solution was vigorously shaken to maintain the reaction solution in a dynamic state, the second solution was added therein and the container was sealed with a film, and the temperature was held at 20° C. while still vigorously shaking the container.

After 2 hours had passed, the substrates were taken out, cleaned with a solution consisting of 0.648 mL of water added to 120 mL of ethanol, dried at 70° C., and then calcined for 48 hours at 350° C. The film thickness of the resulting silica film was examined with an atomic force microscope (AFM) and found to be 0.12 μm. The surface roughness of the silica film had an RMS roughness of 1 nm.

(2) Titania Film Formation

Next, a titania film was formed by the following procedure. A solution was prepared in which 1.35 g of titanium ethoxide was mixed with 100 mL of isopropanol, as well as a solution in which 0.648 mL of water was mixed with 20 mL of isopropanol, and the substrate was immersed in the first solution. While the container with the first solution was vigorously shaken to maintain the reaction solution in a dynamic state, the second solution was added therein, the container was sealed with a film, and the temperature was held at 20° C. while still vigorously shaking the container.

At 4 hours and 8 hours, the substrate was taken out and dried for two hours at 70° C. As a reference, the same treatment was applied to 1) a soda lime glass substrate with no thin silica film on the surface, and 2) a soda lime glass substrate that had a thin silica film on the surface but that had not been calcined at 350° C. after the thin silica film was formed and before the titania thin film was formed. These samples were then heated and calcined at 350° C.

(3) Results

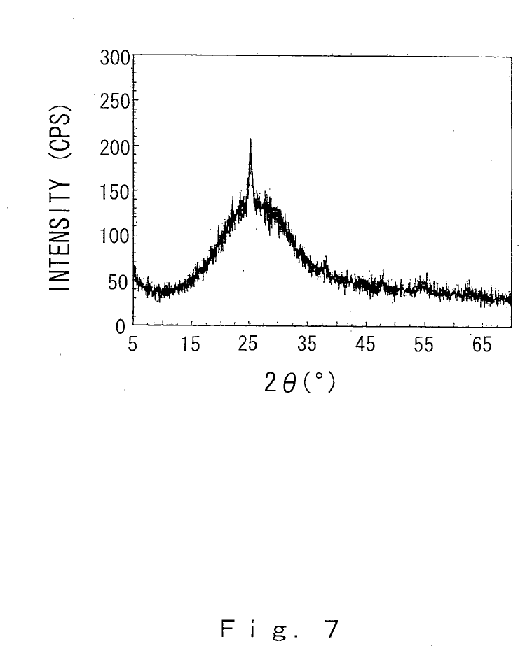

Part of the uncalcined titania thin film formed was peeled off and the film thickness was measured with an atomic force microscope. As a result, the film thicknesses of the samples subjected to 4 and 8 hours of film treatment were 0.09 μm and 0.18 μm, respectively. Next, the presence or absence of a crystal phase was examined with an X-ray diffraction apparatus. As a result, no diffraction lines resulting from a crystal phase were observed in any of the samples. Next, upon examining the presence or absence of a crystal phase in the heated and calcined samples with an X-ray diffraction apparatus, a thin silica film was found to be present between the soda lime glass and the titania thin film, the thickness of the titania film was 0.18 μm, and diffraction lines resulting from a crystalline anatase phase were observed only in the thin silica films that had been calcined at 350° C. (FIG. 7).

Diffraction lines resulting from a crystalline anatase phase were not observed in thin silica films wherein the thickness of the titania film was less than 0.09 μm, even in those that had been calcined at 350° C. The same results were observed in thin silica films for which the calcining conditions were 450° C. and 10 hours.

It is clear from these experiments that the diffusion of chemicals from the substrate is more readily impeded with a thicker thin silica film, which can be converted to the anatase phase even with a thin titania film, and that even a thin silica film can be converted to the anatase phase if the titania film is thick.

### EXAMPLE 4

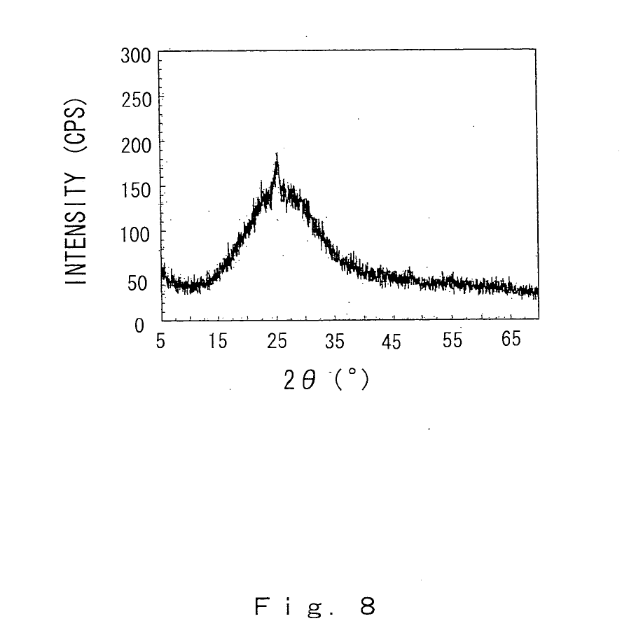

A silica film and a titania film were formed in the same manner as in Example 3 described above. The time to form a titania film was 4 hours for a silica film with a thickness of 0.24 μm. Diffraction lines resulting from a crystalline anatase phase were observed in titania thin films whose thickness was 0.09 μm and which had been calcined at 350° C. for 48 hours. This was because the thickness of the silica film was set to 0.24 μm (FIG. 8).

### EXAMPLE 5

The titanium alkoxide was titanium isopropoxide in the same manner as in Example 3 described above, and a silica glass plate was used instead of a silica film. Diffraction lines resulting from a crystalline anatase phase were observed in samples wherein the time to form a titania film was 6 hours and the titania film thickness was 0.14 μm. The calcining temperature in this case was 300° C., which is lower than in Examples 3 and 4.

### EXAMPLE 6

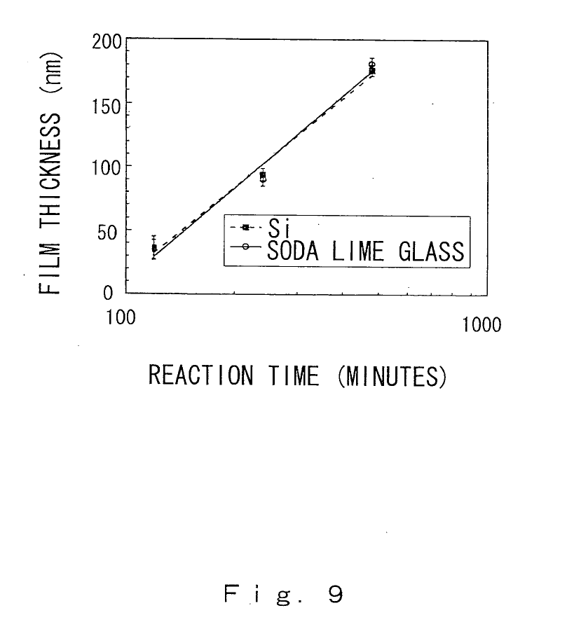

A titania film was formed on the substrate by the same method as in Example 3 described above, and the thickness of the titania film was examined for a case in which a silicon plate and a soda lime glass plate were used as the substrates. As a result, it was clear that the titania film thickness could be expressed as a logarithmic function of the reaction time t (minutes) by the following formulas (FIG. 9).
On silicon plate: d (nm)=232 log(t)−451
On soda lime glass plate: d (nm)=243 log(t)−475

### EXAMPLE 7

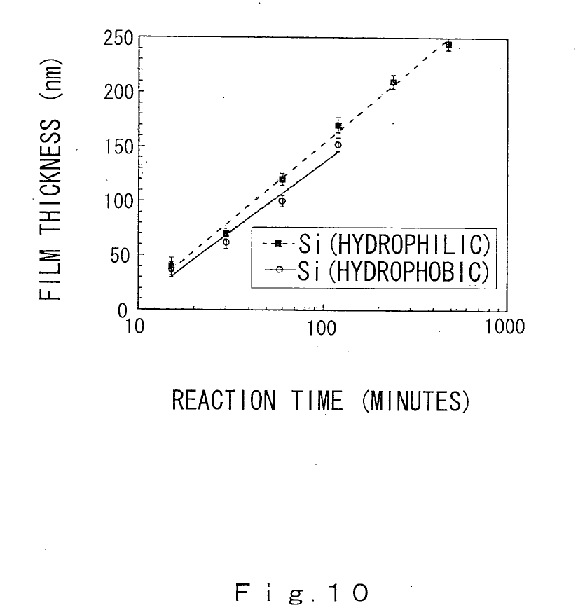

A titania film was formed in the same manner as in Example 3 described above, except that ethanol was used as the solvent, a silicon plate was used as the hydrophilic substrate, and a silicon plate with a hydrophobic surface that had been chemically modified (fluorine treatment) with a monomolecular film of 1H,1H,2H,2H-perfluorodecyl trimethoxysilane was used as the hydrophobic substrate. As a result of measuring and examining the thickness of the resulting titania film with an atomic force microscope, it was clear that the film thickness could be expressed as a logarithmic function of the reaction time t (minutes) by the following formulas (FIG. 10).
On untreated silicon plate: d (nm)=141.89 log(t)−131.17
On hydrophilic treated silicon plate: d (nm)=127.23 log(t)−119.33

### EXAMPLE 8

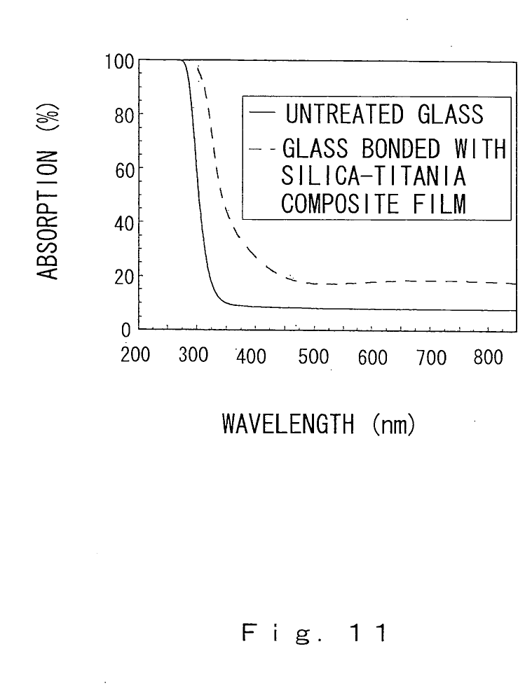

The transmittance of light through ultraviolet and visible light regions was measured in soda lime glass covered on one side with the bonded crystalline anatase-phase composite film formed in Example 3 in which the thin silica film was 0.12 μm and the titania thin film was 0.18 μm. As a result, it was observed that the reduction in light transmittance in all the visible light regions was low, at about 10% (FIG. 11). Also, upon examining the photocatalytic activity of the composite film by regular methods, it was observed that excellent photocatalytic action was achieved due to the presence of the crystalline titania film described above.

### INDUSTRIAL APPLICABILITY

As is described in detail above, the present invention relates to a method for manufacturing a novel thin silica film and to a composite structure, and special operating effects such as the following are achieved by the present invention.

(1) According to the method for manufacturing a thin silica film of the present invention, the thickness of an amorphous thin silica film can be controlled, a film can be formed on a substrate having arbitrary surface characteristics and an arbitrary surface profile, and a uniform and high-quality silica film with a predetermined thickness can be formed on the substrate.

(2) Impurities remaining inside the film can be removed to purify the film by heating and calcining if the temperature is within the upper temperature limit of the substrate.

(3) The thin silica film can be used in a variety of industrial applications, such as in electrical insulating films with electrical insulating properties, high-purity protective films with high intensity, optical waveguide films with high translucence, low reflecting films with minute irregularities in the surface, repairing films for repairing minute defects in a substrate surface to restore its smoothness, and the like.

(4) It is possible to provide a composite structure that possesses high light transmittance and has on the surface thereof a thin silica film obtained by the methods described above.

Also, the present invention relates to a silica-titania composite film and to a manufacturing method and composite structure thereof, and special operating effects such as the following can be achieved by the present invention.

(1) According to the method for manufacturing a silica-titania composite film of the present invention, a crystalline anatase-phase thin film can be formed on a substrate with arbitrary surface characteristics and an arbitrary surface profile if the upper temperature limit of the substrate is 300° C. or more.

(2) This crystalline anatase thin film can be suitably used in industrial applications such as environmental cleanup applications for wastewater treatments, water purification treatments, and other applications utilizing photocatalytic activity; antifouling films with strong hydrophilicity, transparent coherent coloring films, and other such surface decorative applications; photocatalytic functional window glass with photocatalytic activity and transparent properties, and other such home improvement applications; optical waveguide films with a high refractive index; and the like.

(3) It is possible to provide a composite structure that possesses photocatalytic action and has the composite film described above on the surface thereof.

1. A method for preparing a thin silica film bonded to a substrate surface, comprising:
(1) immersing the substrate in a solution composed of a silicon alkoxide, alcohol, water, and an alkali;
(2) producing a low-density silica colloid with a diameter of 1 to 30 nm in the solution by hydrolysis of the silicon alkoxide in the alcohol solvent;
(3) forming a uniform thin silica film with a predetermined thickness on the substrate in the solution through deposition and dehydropolycondensation of these materials on the substrate; and
(4) maintaining the reaction solution in a dynamic state in the film formation steps described above.

2. The method according to claim 1, wherein the silicon alkoxide is at least one compound selected from the group consisting of silicon tetramethoxide, silicon tetraethoxide, silicon tetraisopropoxide, and silicon tetrabutoxide.

3. The method according to claim 1, wherein the alcohol, which is a solvent, is at least one member selected from the group consisting of methanol, ethanol, and isopropanol.

4. The method according to claim 1, wherein the thickness of the silica film is 1 nm to 10 μm.

5. The method according to claim 1, wherein the reaction solution is maintained in a dynamic state by shaking the reaction solution to promote deposition of the low-density silica colloid onto the substrate.

6. The method according to claim 1, wherein the reaction solution is maintained in a dynamic state by circulating the solvent, vibrating the substrate, or vigorously shaking a reaction tank.

7. The method according to claim 1, wherein the surface roughness of the thin film is controlled by setting the hydrophobicity of the substrate surface.

8. The method according to claim 1, wherein a predetermined film thickness is achieved by arbitrarily setting the starting time for substrate immersion and the subsequent holding time.

9. The method according to claim 1, wherein the substrate is a substrate whose surface has been made hydrophobic via chemical modification typified by fluorine treatment, silicone rubber, an acrylic resin, or cellulose.

10. A method for manufacturing a thin silica film, characterized in that the thin silica film obtained by the method according to any one of claims 1 through 9 is dried.

11. The method according to claim 10, wherein the density of the film is arbitrarily set via heat treatment after drying.

12. A composite structure with high light transmittance, characterized by having on the surface thereof the thin silica film obtained by the method according to any one of claims 1 through 11.

13. A method for preparing a composite film having one or a plurality of layers of a metal compound film with a metal other than titanium as a component, and having a titanium oxide film on the outermost surface; comprising:
(1) immersing a substrate having one or a plurality of layers of a metal compound film with a metal other than titanium as a component on the surface thereof in a titanium alkoxide solution;
(2) producing a low-density titania colloid with a diameter of 1 to 30 nm in the solution through hydrolysis of the titanium alkoxide; and
(3) coating the surface of the substrate with titanium oxide in the solution through deposition and dehydropolycondensation of these materials on the substrate.

14. The method according to claim 13, wherein the metal compound film with a metal other than titanium as a component comprises amorphous silica.

15. The method according to claim 14, wherein the film comprising amorphous silica is increased in density via heat treatment.

16. The method according to claim 13, wherein the titanium alkoxide is at least one or more compounds selected from the group consisting of titanium tetramethoxide, titanium tetraethoxide, titanium tetraisopropoxide, and titanium tetrabutoxide.

17. The method according to claim 13, wherein the alcohol, which is a solvent, is at least one member selected from the group consisting of methanol, ethanol, and isopropanol.

18. The method according to claim 13, wherein the holding temperature of the reaction solution is 0° C. or more and 100° C. or less.

19. A method for preparing a composite film, comprising converting titanium oxide to the crystalline anatase phase by applying heat treatment to the composite film obtained by the method according to any one of claims 13 through 18.

20. The method according to claim 18, wherein the heat treatment is performed at 300° C. or more and 1000° C. or less.

21. A composite film obtained by the method according to any one of claims 13 through 20, characterized by having one or a plurality of layers of a metal compound film with a metal or a plurality of layers of a metal compound film with a metal other than titanium as a component that are bonded to the surface of the substrate and that have a uniform thickness of 0.01 to 100 μm; and by having a titanium oxide film with a uniform thickness of 0.01 to 100 μm on the outermost surface.

22. A composite structure with photocatalytic action, characterized by having the composite film according to claim 21 on the surface thereof.
